(19) United States
(12) Patent Application Publication
(10) Pub. No.: US 2016/0309755 A1
(43) Pub. Date: Oct. 27, 2016

(54) NUTRITIONAL COMPOSITIONS CONTAINING RICE PROTEIN TOGETHER WITH PEA AND/OR POTATO PROTEINS

(71) Applicant: Abbott Laboratories, Abbott Park, IL (US)

(72) Inventors: Douglas Wearly, Blacklick, OH (US); Paul JOHNS, Columbus, OH (US); Normanella DEWILLE, Columbus, OH (US); Rachel BLUMBERG, Dublin, OH (US); Jeffrey BAXTER, Westerville, OH (US)

(21) Appl. No.: 15/102,308

(22) PCT Filed: Dec. 9, 2014
(86) PCT No.: PCT/US2014/069215

§ 371 Date: Jun. 7, 2016

Related U.S. Application Data
(60) Provisional application No. 61/913,609, filed on Dec. 9, 2013.

(51) Int. Cl. A23L 2/66; A23L 2/52; A23L 33/185; A23L 33/19; A23L 33/125; A23L 33/115

(52) U.S. Cl. CPC A23L 2/66; A23L 33/125; A23L 33/115; A23L 33/185; A23L 33/19; A23L 2/52; A23V 2002/00

(57) ABSTRACT

The combination of potato protein, intact rice protein and hydrolyzed rice protein, replaces a portion of the vegetable protein in a nutrition shake or other nutritional composition intended for oral consumption. By suitable selection of the types and amounts of these proteins the overall cost of manufacturing the nutritional composition can be reduce without adversely affecting its other desirable properties such as nutritional value, stability, taste and mouthfeel.

### CROSS REFERENCE TO RELATED APPLICATIONS

This application claims priority to and any benefit of U.S. Provisional Application No. 61/913,609, filed Dec. 9, 2013, the entire contents of which are incorporated by reference in its entirety.

### BACKGROUND OF THE INVENTION

Nutrition shakes, i.e., non-carbonated liquid nutritional compositions which are intended for oral consumption and therefore have the consistency, flavor and overall desirable sensory characteristics of common every-day milk shakes, are widely-available consumer products. Examples include the Ensure®, Glucerna®, Myoplex® and Pediasure® line of nutrition shakes available from Abbott Nutrition of Columbus, Ohio, the Muscle Milk® line of nutrition shakes available from CytoSport, Inc. of Benicia, Calif., and the Resource® line of health shakes available from Nestle, S.A. of Vevey, Switzerland. Generally, they contain balanced amounts of macronutrients (proteins, fats and carbohydrates) as well as micronutrients and flavorings, and are made up in the form of oil-in-water emulsions having the consistency of common every-day milk shakes.

To reduce costs, vegetable proteins may be used as part of the protein component of such compositions. Soy protein is especially preferred, due to its relatively low cost, agreeable texture and faint flavor. However, experience has shown that the amount of vegetable protein in such compositions, as a percentage of total protein, should be limited to a maximum of about 30 wt. %, even if soy protein is used. This is because both flavor and stability, both short term and long term, begin to suffer at higher concentrations.

To reduce costs even further, recently published WO 2010/126362 A1 to Hofman et al., recommends that intact pea protein, which is even less expensive than soy protein, be used to replace a portion of the protein in such compositions. Pea protein has been used for years as a partial protein source in liquid nutritional compositions. However, pea protein is known to adversely affect the desirable properties a nutrition shake must have to be commercially successful such as stability, flavor, texture, mouth feel, odor, overall liking and so forth. Accordingly, the challenge in using intact pea protein to reduce the cost of making such compositions is not merely replacing a portion of its existing protein with intact pea protein, but rather doing so in a way which does not adversely affect its other desirable properties.

The '362 published application does not address these issues, since its clear focus is on nutritional compositions for tube feeding. Furthermore, its specific disclosure indicates that the animal protein of its compositions should be composed of a large excess of whey protein, i.e., about 35 wt. % whey protein and 25 wt. % casein, based on total protein. This means that significant amounts of additional whey protein, typically in the form of whey protein concentrate (WPC) or whey protein isolate (WPI), need to be added to achieve this requirement, since the natural distribution of milk proteins in milk is about 20 wt. % whey protein and 80 wt. % casein. Whey protein is more expensive than other types of milk proteins, and much more expensive than pea and other vegetable proteins. Therefore, using large amounts of whey protein as taught by this document defeats the underlying purpose of using pea protein to reduce costs.

Commonly assigned international application S.N. PCT/US 13/33883, the entire disclosure of which is incorporated herein by reference, describes another approach for increasing the concentration of vegetable protein in a nutrition shake without adversely affecting its desirable properties. As described there, the amount of vegetable protein in such compositions can be increased to levels as high as 55% or more, based on total protein, without requiring that additional amounts of whey protein be added, by using both intact pea protein and intact soy protein as the vegetable protein source, but only if (a) the combined amount of intact pea protein and intact soy protein represents about 32 to 55 wt. % of total protein, (b) the amount of intact pea protein represents about 14 to 90 wt. % of the combined amount of intact soy protein and intact pea protein, (c) the amount of milk protein represents about 40 to 68 wt. % of total protein, and (d) at least 80 wt. % of the milk protein is supplied in the form of a natural milk protein concentrate (MPC), i.e., a milk protein concentrate containing about 70 to 90 wt. % milk proteins and a natural distribution of whey protein and casein (i.e., a whey protein/casein ratio between about 10:90 and 30:70).

### SUMMARY OF THE INVENTION

In accordance with this invention, it has been found that the amount of vegetable protein in nutritional compositions can be increased to levels as high as 65% or more, based on total protein, without adversely affecting desirable properties such as nutritional value, stability, flavor and mouth feel, and also without requiring that additional amounts of whey protein be added, by selecting as the vegetable proteins to be used for this purpose either (a) the combination of soy protein, or slightly hydrolyzed soy protein and at least one of potato protein, intact rice protein and hydrolyzed rice protein, or (b) legume protein having a reduced phytic acid content.

Thus, this invention, in a first aspect, provides a nutritional composition comprising a protein component in an amount of from about 1.0% to about 20% by weight, a carbohydrate component in an amount of from about 5.0% to about 65% by weight, and a fat component in an amount of from about 1.0% to about 20% by weight, the percents being based on the weight of the nutritional composition as a whole, wherein the protein component comprises (b i) about 35 to 60 wt. % milk protein and (b ii) 30 to 65 wt. % vegetable protein, wherein at least half of the vegetable protein is composed of the combination of soy protein and at least one of potato protein, intact rice protein and hydrolyzed rice protein having a degree of hydrolysis (DH) of about 5 to 25%.

In a second aspect, this invention further provides a nutritional composition comprising a protein component in an amount of from about 1.0% to about 20% by weight, a carbohydrate component in an amount of from about 5.0% to about 65% by weight, and a fat component in an amount of from about 1.0% to about 20% by weight, the percents being based on the weight of the nutritional composition as a whole, wherein the protein component comprises (c i) 100% vegetable protein, wherein at least half of this vegetable protein is composed of one or more legume proteins exhibit a reduced phytic acid concentration, and further wherein the protein component meets the current (2013) FAO protein quality requirements for normal health adults.

### DETAILED DESCRIPTION

### Definitions and Conventions

For the purposes of this disclosure, the following terms have the following meanings unless context dictates otherwise:

“Aseptic packaging” refers to the manufacture of a packaged product without reliance upon a retort packaging step as described below, wherein the liquid nutritional composition and package are sterilized separately prior to filling, and then are combined under sterilized or aseptic processing conditions to form a sterilized, aseptically packaged, liquid nutritional product.

“Fat” and “oil” as used herein are used interchangeably to refer to lipid materials derived or processed from vegetables or animals. These terms also include synthetic lipid materials so long as such synthetic materials are suitable for oral administration to humans. As well known, such materials are normally composed of mixtures of fatty acid triglycerides, which mixtures may also contain fatty acid diglycerides and monoglycerides and even some free fatty acids.

“Intact protein” or “intact protein source” refers to a protein or protein source which is unhydrolyzed.

“Intact protein source” or “source of intact protein” refers to a source of protein which has not been subjected to a specific treatment whose primary purpose is to hydrolyze unhydrolyzed proteins.

“Nutritional composition” or “nutritional product” refers to nutritional liquids, nutritional powders which may be reconstituted to form a nutritional liquid, nutritional puddings, nutritional gels, nutrition bars, and other nutritional products all of which comprise one or more of fat, protein, and carbohydrate and are suitable for oral consumption by a human.

“Nutrition shake” refers to a liquid nutritional composition that is intended for oral consumption by the ordinary consumer and hence is formulated, manufactured, packaged and sold in the form of a viscous liquid having the pleasing flavor and the consistency of a conventional milk shake.

“Retort packaging” and “retort sterilizing” are used interchangeably herein and refer to the common practice of filling a container, most typically a plastic or metal can or other similar package, with a liquid nutritional composition and then subjecting the liquid-filled package to the necessary heat sterilization step to form a sterilized, retort packaged, liquid nutritional product.

“Shelf stable” refers to a liquid nutritional composition that remains commercially stable after being packaged and then stored at 18-24° C. for at least 3 months.

“Total protein” in connection with the amount of protein in a particular composition means all the protein in that composition.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

“About” when used in connection with a range such as, for example, “about 8% to 12%” will be understood to mean about 8% to about 12%.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The compositions of this disclosure may also be substantially free of any optional or selected ingredient or feature described herein. In this context, “substantially free” means that the selected nutritional composition contains less than a functional amount of the optional ingredient, typically less than 1%, including less than 0.5%, including less than 0.1%, and also including zero percent, by weight of such optional or selected ingredient.

In addition, the compositions of this disclosure may comprise, consist of, or consist essentially of the recited elements, as described herein.

### Product Form

The nutritional compositions of this invention include ready-to-feed liquids, concentrated liquids, liquids derived from nutritional powders (reconstituted liquids), powders, and other solids such as nutrition bars. These liquid compositions may include solutions (including clear solutions), suspensions, and emulsions. The powders that are reconstituted to produce a liquid may include any flowable or scoopable particulate solid that can be diluted with water or other aqueous liquid to form a nutritional liquid prior to use.

The nutritional compositions may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit.

### Nutritional Powders

The nutritional powders may be reconstituted by the intended user with a suitable aqueous liquid, typically water or other aqueous liquid, in an amount or volume sufficient to form a nutritional liquid for immediate oral use. In this context, “immediate” use generally means within about 48 hours, more typically within about 24 hours, most typically right after or within 20 minutes of reconstitution. Further, when reconstituted, the nutritional powders provide the desired ingredient concentrations as described hereinafter for the nutritional liquid embodiments.

The nutritional powders may include spray dried powders, dry mixed powders, agglomerated powders, combinations thereof, or powders prepared by other suitable methods.

### Nutritional Liquids

The nutritional liquids may be formulated in a variety of forms, including emulsions such as oil-in-water, water-in-oil, or complex aqueous emulsions, although such emulsions are most typically in the form of oil-in-water emulsions having a continuous aqueous phase and a discontinuous oil phase, suspensions, or clear or substantially clear liquids.

The nutritional liquids may be and typically are shelf stable. The nutritional liquids typically contain up to 95% by weight of water, including from about 50% to 95%, also including from about 60% to about 90%, and also including from about 70% to about 85%, of water by weight of the nutritional liquid.

### Macronutrient Balance

The inventive nutritional compositions contain proteins, fats and carbohydrates in proportions which are suitable for satisfying the nutritional needs of the consumer or patient for which they are intended. Such proportions are well known in the art, and any conventional proportion can be used

This invention is especially useful in connection with formulating nutrition shakes, i.e., liquid nutritional compositions that are intended for oral consumption by the ordinary consumer and hence are formulated to have a pleasing flavor and the consistency of a conventional milk shake, as well as powders and concentrates which can be combined with water to form such nutrition shakes. A variety of nutrition shakes are well known commercial products, including those especially formulated for promoting muscle growth, those especially formulated to provide balanced nutritional supplements for normal adults, those especially formulated for diabetic adults and those formulated especially for children (e.g., ages 1 to 6) both as supplements as well as sole source foodstuffs. Broadly speaking, these nutrition shakes when in a ready to feed condition contain protein in an amount of from about 0.5% to about 20% by weight, carbohydrate in an amount of from about 0.5% to about 35% by weight, and fat in an amount of from about 0.1% to about 25% by weight, with the particular balance of these macronutrients depending on the specific purpose for which a particular shake is formulated.

Thus, such compositions when in a ready to use condition typically contain concentrations of these macronutrients as set forth in the following Tables 1 to 4, with the percentages shown being based on the entire weight of each composition:

TABLE 1
Nutrition Shakes-Muscle Building Formulations
Macronutrient Breakdown

| | wt. %, based on entire | | | | | |
|---|---|---|---|---|---|---|
| | composition | | | Calorie % | | |
| | Protein | Carbs | Fat | Protein | Carbs | Fat |
| Operative | 3-20 | 0.5-15 | 1-10 | 35-75 | 5-40 | 5-40 |
| Desirable | 5-15 | 1-10 | 0.3-5 | 45-70 | 10-35 | 10-35 |
| More Desirable | 6-10 | 2-6 | 0.5-2 | 40-65 | 15-30 | 15-30 |
| Especially | 6-10 | 3-5 | 0.7-1.5 | 54-58 | 21-25 | 19-23 |
| Desirable | | | | | | |

TABLE 2
Nutrition Shakes-Balanced Adult Supplement
Macronutrient Breakdown

| | wt. %, based on entire | | | | | |
|---|---|---|---|---|---|---|
| | composition | | | Calorie % | | |
| | Protein | Carbs | Fat | Protein | Carbs | Fat |
| Operative | 0.5-15 | 10-30 | 0.5-10 | 2-30 | 30-90 | 6-45 |
| Desirable | 1.4-8.5 | 11-25 | 1-7 | 6-25 | 40-80 | 10-40 |
| More Desirable | 2-7 | 13-24 | 1.5-6 | 10-20 | 45-75 | 15-35 |
| Especially Desirable | 2.9-5.8 | 14-20 | 2-5 | 12-17 | 50-70 | 20-31 |

TABLE 3
Supplement for Diabetics
Macronutrient Breakdown, wt. %

| | wt. %, based on entire | | | | | |
|---|---|---|---|---|---|---|
| | composition | | | Calorie % | | |
| | Protein | Carbs | Fat | Protein | Carbs | Fat |
| Operative | 0.5-15 | 5-35 | 0.5-20 | 10-40 | 20-70 | 15-55 |
| Desirable | 1-10 | 7-20 | 0.7-15 | 12-35 | 30-60 | 20-45 |
| More Desirable | 2-7 | 8-15 | 1-10 | 15-30 | 35-55 | 25-40 |
| Especially Desirable | 3-5 | 9-12 | 1.5-5 | 18-25 | 40-50 | 30-35 |

TABLE 4
Nutrition Shakes-Children's Drink
Macronutrient Breakdown

| | wt. %, based on entire | | | | | |
|---|---|---|---|---|---|---|
| | composition | | | Calorie % | | |
| | Protein | Carbs | Fat | Protein | Carbs | Fat |
| Operative | 0.5-10 | 4-40 | 1-25 | 2-40 | 30-80 | 15-55 |
| Desirable | 0.7-7 | 6-30 | 1.2-20 | 4-30 | 40-70 | 20-45 |
| More Desirable | 1-6 | 8-20 | 1.5-15 | 7-20 | 45-65 | 25-40 |
| Especially Desirable | 2-4 | 10-15 | 2-7 | 10-15 | 50-60 | 30-35 |

### Carbohydrates

Any carbohydrate or source thereof that is suitable for use in oral nutritional products and is compatible with the other ingredients of the inventive compositions can be used as the carbohydrate of the inventive nutritional compositions. Specific examples include maltodextrin (and specifically low DE Maltodextrin such as DE10 maltodextrin), corn maltodextrin, sucromalt, maltitol, maltitol powder, glycerine, glucose polymers, corn syrup, corn syrup solids, rice-derived carbohydrates (e.g., tapioca dextrin), isomaltulose, sucrose, extra fine white sugar, glucose, fructose, lactose, high fructose corn syrup, honey, sugar alcohols (e.g., maltitol, erythritol, sorbitol), artificial sweeteners (e.g., sucralose, acesulfame potassium), natural sweeteners (e.g., stevia, monk fruit), high potency potientiators, fructooligosaccharides, soy fiber, corn fiber, guar gum, konjac flour, polydextrose, Fibersol, and combinations thereof.

Normally, the carbohydrate component of the inventive nutritional compositions will contain both starches and sugars. If so, the amount of sugar in nutritional compositions especially formulated for promoting muscle growth in adults may desirably represent about 1% to about 20%, about 3% to about 10%, or even about 4% to about 8%, by weight, of the total amount of carbohydrates in the composition. Similarly, the amount of sugar in nutritional compositions especially formulated to provide balanced nutritional supplements for normal adults, as well as for diabetic adults, may desirably represent about 10% to about 35%, about 15% to about 30%, or even about 20% to about 25%, by weight, of the total amount of carbohydrates in the composition. In addition, the amount of sugar in nutritional compositions especially formulated for children (e.g., ages 1 to 16), both as supplements as well as sole source foodstuffs, may desirably represent about 30% to about 70%, about 40% to about 65%, or even about 50% to about 60%, by weight, of the total amount of carbohydrates in the composition.

### Fat

Any fat or source thereof that is suitable for use in oral nutritional products and is compatible with the other ingredients of the inventive compositions can be used as the fat of the inventive nutritional compositions. Desirably, a fat source will provide at least one long chain polyunsaturated acid (LC-PUFA) such as DHA, ARA, and/or EPA, although these LC-PUFAs may be optionally added to the nutritional compositions outside of, or in addition to, the fat source.

Non-limiting examples of suitable fats or sources thereof for use in the nutritional compositions of this invention include coconut oil, fractionated coconut oil, soy oil, corn oil, olive oil, safflower oil, high oleic safflower oil, MCT (medium chain triglycerides) oil, sunflower oil, high oleic sunflower oil, palm and palm kernel oils, palm olein, canola oil, marine oils, cottonseed oils, and combinations thereof.

### Protein

In addition to fats, carbohydrates and optional ingredients as more fully discussed below, the inventive nutritional compositions contain proteins. Traditionally, milk proteins have been the proteins of choice for making a wide variety of different nutritional compositions. For various reasons, however, including cost, efforts have been undertaken to replace some or all of these milk proteins with vegetable proteins. The problem, however, is that vegetable proteins normally exhibit a negative effect on the desirable properties that nutritional compositions exhibit including flavor, odor, viscosity (in the case of liquids), texture, short term stability, long term (shelf) stability and nutritional value. In accordance with this invention, it has been found that particular combinations of particular vegetable proteins can be used to reduce the total amount of dairy proteins needed in such compositions protein without adversely affecting their taste, nutritional value and other hedonic properties including appearance and mouthfeel (creaminess, viscosity).

Specific proteins that can be used to make the nutritional compositions of this invention are more fully discussed below:

### Milk Protein

The inventive nutritional compositions contain a substantial amount of milk or dairy protein.

Milk proteins that are useful in this invention can be obtained from the milk of many different mammals including cows, sheep, goats, horses, buffalos, camels, etc. Milk proteins derived from cow's milk are preferred due to availability and cost.

There are two basic types of milk proteins, casein and whey. They naturally occur in a weight ratio of about 20 wt. % whey and 80 wt. % casein in the milk of most mammals, including cow's milk.

Milk proteins are commercially available in a variety of different forms. Examples include milk protein isolates, concentrates, caseinates, whey isolates or concentrates, milk, non-fat dry milk, and condensed skim milk, micellar proteins such as micellar caseins and micellar milk protein concentrate all of which are useful in this invention. In some forms, the natural distribution of whey and casein is preserved. In other forms, the whey or the casein is concentrated relative to the other.

Whey protein is commercially available as liquid whey or in powder form as whey protein isolate (WPI) or whey protein concentrate (WPC). All have an elevated whey protein/casein ratio relative to whole milk. WPC is normally produced by membrane filtration. It is rich in whey proteins, but also contains other components such as fat, lactose and, in the case of whey protein produced from cheese, glycomacroprotein (GMP), a casein-related non-globular protein. In contrast, WPI consists primarily of whey proteins with minimal amounts of fat and lactose. WPI usually requires a more rigorous separation process such as a combination of microfiltration and ultra-filtration or ion exchange chromatography. It is generally understood that WPI refers to a mixture in which at least 90 weight % of the solids are whey proteins. A WPC is understood as having a percentage of whey proteins between the initial amount in the by-product (about 12 weight %) and a WPI. In particular, sweet whey, obtained as a by-product in the manufacturing of cheese, acid whey, obtained as a by-product in the manufacturing of acid casein, native whey, obtained by milk microfiltration or rennet whey, obtained as a by-product in the manufacturing of rennet casein, may be used alone or in combination as a source of globular whey proteins.

Casein separates from milk when milk is curdled, a process commonly carried out in the manufacturing of cheese, and is commonly called caseinate, having lost its typical micellar structure. Casein is most commonly bound to calcium (Ca²⁺) and sodium (Na⁺) since all of these ions are found naturally in milk, or even potassium (K⁺) or magnesium (Mg²⁺), and tend to stick to the casein during the extraction process. Nutritionally, these compounds are basically interchangeable, as all forms of casein are effective protein sources. Micellar casein refers to casein in the form of native micelles. It is a high quality milk protein and naturally occurring in milk in a concentration of about 2.6 g/100 ml. It is concentrated by a process that does not, or does not substantially, denature the casein proteins and it is marketed as Micellar Casein Isolate (MCI). Fresh skim milk is subjected to a microfiltration process, in much the same process used to concentrate whey protein, to produce a pure, substantially undenaturated milk protein with its native structure. The resulting material contains between 90% and 95%, preferably more than 95% by weight of micellar casein, the rest mainly being whey protein and other non-protein nitrogen and other constituents, such as lactose and inorganic salts, in particular calcium phosphate.

Two milk protein sources in which the natural distribution of whey and casein is essentially preserved are milk protein concentrate (MPC) and milk protein isolate (MPI). MPC and MPI are products in which a substantial amount of the water and fat in whole milk have been removed. MPIs are further characterized in that a significant portion of the lactose has also been removed. As a result, the concentration of milk proteins in an MPI is normally greater than that found in a typical MPC, although this is not always the case.

For the purposes of this disclosure, therefore, MPC will be understood to be a generic term, which includes MPI as a specie thereof. Thus, MPC will be understood to refer to a milk protein product in which greater than 55% of the non-fat solids in the product are milk proteins, with the ratio of whey proteins to casein in the product being between 2:98 and 50:50. More commonly, more than 75 wt. % of the non-fat solids in the product are milk proteins, with the ratio of whey proteins to casein being between 10:90 and 30:70, even most typically between 10:90 and 20:80.

Milk protein isolates (MPIs) will be understood to mean a type of MPC in which at least 85 wt. % of the non-fat solids in the product are milk proteins, the lactose content is 5 wt. % or less, the fat content is less than 3 wt. %, the ash content is 8 wt. % or less, and the water content is less than 6 wt. %. Commercially available MPIs typically contain about 85-90 wt. % (or more) protein, about 2-5 wt. % lactose, minimal fat (i.e., 1-3 wt. %) and about 5-6 wt. % water.

In some embodiments of this invention, a conventional milk protein concentrate (MPC), i.e., milk protein concentrate containing about 70 to 90 wt. % milk proteins and a natural distribution of whey and casein (i.e., whey protein/casein ratios between about 10:90 and 30:70), is used to supply most or even all of the milk proteins in the inventive nutritional compositions. Preferably, the natural milk protein concentrate contains about 75 to 85 wt. % protein and has a whey protein/casein ratio between about 10:90 and 20:80. These milk protein sources are preferred, because they are relatively inexpensive, readily available, have a preferred flavor profile, and exhibit a beneficial effect on product stability. In addition, they already exhibit a natural distribution of whey protein and casein, e.g., about 20/80 on a weight basis.

### Concentrated Soy Protein Product

In some embodiments of this invention, the inventive nutritional compositions also contain soy protein. Both intact soy protein and hydrolyzed soy protein sources can be used. In this context, “intact” in connection with a protein means that the protein is unhydrolyzed. In contrast, “intact” in connection with a protein source means that the protein source has not been subjected to a treatment whose primary purpose is to hydrolyze unhydrolyzed proteins, even though it may contain a significant amount of hydrolyzed proteins. In this regard, it is conventional in this industry to refer to a protein source which has been subjected to a treatment whose primary purpose is to hydrolyze unhydrolyzed proteins as a source of hydrolyzed proteins, e.g., “hydrolyzed pea protein concentrate.” In contrast, when a protein source has not been subjected to such a treatment, it is conventional practice to refer to this product as a source of unhydrolyzed or intact proteins, or more commonly to say nothing about the hydrolysis of its proteins, even though a significant amount of the proteins therein may be in hydrolyzed form. For example, referring to a “soy protein concentrate,” without more, connotes that this source has not been subjected to a treatment whose primary purpose is to hydrolyze its unhydrolyzed proteins, even though it is well known that as many as 50% of the proteins in this source may be in hydrolyzed form.

This conventional practice is followed in this disclosure. So, for example, reference to a milk protein concentrate (MPC), pea protein concentrate (PPC) or soy protein isolate (SPI) in this disclosure connotes that this protein source has not been subjected to a treatment whose primary purpose is to hydrolyze the unhydrolyzed proteins therein, even though it may contain a significant amount of hydrolyzed proteins due to naturally occurring phenomena. In contrast, reference to a protein (as opposed to a protein source) which is intact means that the protein itself is unhydrolyzed.

Soy protein is a vegetable protein that contains most essential amino acids in a relatively high proportion. Soy protein can be divided into different categories according to its production method. For the purposes of this disclosure, “soy protein concentrate” (SPC) will be understood to be a generic term referring to products which are basically soybean without the water soluble carbohydrates and which contain about 60 to 90 wt. % or more soy protein. More commonly, these products contain 60 to 85 wt. % soy protein, and even more typically 70 to 80 wt. % soy protein. Meanwhile, “soy protein isolate” (SPI) will be understood to mean a type of SPC which contains about 85 to 90 wt. % protein. SPI is the most refined form of soy protein and is mainly used in meat products to improve texture and eating quality. Textured soy protein (TSP) is made from soy protein concentrate by giving it some texture. TSP is available as dry flakes or chunks. It will keep its structure when hydrated. Hydrated textured soy protein chunks have a texture similar to ground beef. It can be used as a meat replacement or can be added to meat. Textured soy protein contains about 70 wt. % protein.

Any of these concentrated soy protein sources can be used to provide the intact soy protein of the nutrition shakes of this first aspect of the invention. Soy protein concentrates and isolates containing about 70 to 87 wt. % protein are preferred.

Several soy protein sources are readily available to the skilled person, for example, from The Solae Company of St. Louis, Mo., USA, and the Arthur Daniels Midland Company of Decatur, Ill., USA.

### Pea Protein

In some embodiments, the inventive nutritional compositions contain pea protein. Both intact and hydrolyzed pea protein sources can be used. Particularly suitable pea proteins for use in the inventive nutritional compositions include pea proteins derived from Pisum sativum. Pea proteins derived from other species of peas, including green peas and field peas, can also be used.

Pea protein is commercially available in the form of pea protein concentrates (PPC) and pea protein isolates (PPI). For the purposes of this disclosure, PPC will be understood to refer to concentrated pea protein sources containing 60 to 90 wt. % pea protein. Meanwhile, PPI will be understood to refer to a PPC which contains 80 to 90 wt. % pea protein. These PPCs and PPIs typically exhibit one or more of the following attributes: (1) poured bulk density, as measured by gravimetry, of about 0.4 Kg/L; (2) a pH in a 10% solution of water of about 7; (3) a residue on a 70 mesh screen as measured by sieving of a maximum of 10% by weight; (4) a carbohydrate concentration of about 3 grams per 100 grams of intact pea protein; (5) a fat concentration of about 6 grams per 100 grams of intact pea protein; and/or (6) an ash concentration of about 4 grams per 100 grams of intact pea protein.

One suitable commercially available intact pea protein concentrate that can be used to make the nutritional compositions of this disclosure and which is based on pisum sativum is NUTRALYS® F85F pea protein isolate (about 83% by weight intact pea protein), available from Roquette Freres, Lestrem France. Another source for intact pea protein based on pisum sativum is Cosucra Groupe Warcoing of Warcoing, Belgium.

### Rice Protein

In some embodiments of this invention, the inventive nutritional compositions also contain rice protein. Rice proteins derived from both Asian rice (Oryza sativa) and African rice (Oryza glabemma) can be used. These proteins can be either in white rice form or brown rice form. That is to say, both white rice proteins and brown rice proteins can be used to make the inventive nutritional compositions.

As is well-known, brown rice, which is sometimes referred to as “hulled” or “unmilled” rice, is whole grain rice, i.e., rice in which the hull has been removed but the bran and the germ have not. In contrast, white rice is rice in which the hull, bran and germ have all been removed.

Brown rice protein is commercially available in the form of brown rice protein concentrates and isolates. These sources are available from a wide variety of different manufacturers including Nutribiotic, Jarrow Formulas, Vitacost, Sunwarrier, and Axiom Foods and AIDP (sprouted brown rice). All can be used to make the nutritional compositions of this invention.

A particularly interesting source for intact brown rice protein for use in this invention is the ORYZATEIN™ line of brown rice protein powders sold by Axiom Foods, Inc. of Los Angeles, Calif. and distributed by Prinova, USA of Carol Stream, Ill. These protein powders, which contain 70%, 80% and 90% protein, are especially useful in making stable liquid suspensions.

Like brown rice protein, white rice protein is also commercially available in the form of white rice protein concentrates and isolates. These products are available from a wide variety of different commercial sources including Shanghai Freemen Chemicals Company, LLC. of Shanghai, China. All can be used to make the nutritional compositions of this invention.

A particularly interesting source for white rice protein for use in this invention is the Gabioten line of white rice protein products sold by Shanghai Freemen. These products, which are available in powder form containing 70%, 80% and 90% protein, are especially suitable for use in this invention, especially the powder containing 90% protein.

Both of these rice proteins, i.e., both the brown rice proteins and the white rice proteins, can be used in hydrolyzed form as well as in intact form. If used in hydrolyzed form, hydrolysis of these rice proteins can be accomplished by any known technique to a degree of hydrolysis which will normally be about 1 to 50%, more desirably about 2 to 20% or even about 5 to 15%.

Hydrolyzed rice proteins are commercially available in the form of concentrates and isolates containing 70%, 80% and 90% protein, and having degrees of hydrolyzation ranging anywhere from 1 to 50%. For example, such products are available from a wide variety of different commercial sources including Axiom and Suan Pharma. All can be used to make the nutritional compositions of this invention.

### Potato Protein

In some embodiments of this invention, the inventive nutritional compositions contain potato protein.

Both intact and hydrolyzed versions of these potato proteins can be used, with the degree of hydrolysis of the hydrolyzed versions ranging from about 1 to 20%, more desirably about 5 to 15%, or even about 5 to 10%.

Potato proteins are commercially available in the form of concentrates and isolates containing 80% to 95% protein. They are available, for example, from Solanic, which is a subsidiary of AVEBE of Veedam, The Netherlands.

### Free Amino Acids

In addition to the above proteins, fats and carbohydrates, the inventive nutritional compositions can also contain free amino acids, if desired. Examples include L-arginine, L-cysteine, L-glutamine, L-leucine, L-proline, valine, isoleucine, and L-tryptophan. Particularly suitable free amino acids include L-arginine and L-glutamine. Desirable branched chain amino acids include leucine, isoleucine, and valine.

These free amino acids may also be present in salt form (e.g., L-arginine hydrochloride), peptide-bound form (e.g., L-alanyl-L-glutamine), and protein-bound form (e.g., bovine beta-lactoglobulin, which includes 2.85 wt. % arginine, 7.18 wt. % glutamine and 15.76 wt. % leucine). Although all of these forms are suitable and within the scope of this invention, the free form is particularly suitable as it is the most concentrated and the addition rate of the free acids into the nutritional composition can be easily controlled.

The total amounts of these free amino acids in the inventive nutritional compositions should not exceed 5 grams/100 ml. More desirably, the amount of free amino acids in the inventive nutritional compositions is ≦2 grams/100 ml., more desirably ≦1 gram/100 ml. or even <0.5 gram/100 ml.

### Optional Ingredients

The inventive nutritional compositions may further comprise other optional ingredients that may modify their physical, chemical, hedonic or processing characteristics or serve as pharmaceutical or additional nutritional components when used in the targeted population. Many such optional ingredients are known or otherwise suitable for use in other nutritional compositions and may also be used in the nutritional compositions described herein, provided that such optional ingredients are safe and effective for oral administration and are compatible with the essential and other ingredients in the selected product form.

For example, in addition to the proteins mentioned above, the inventive nutritional compositions can contain other proteins that are useful in formulating nutritional compositions.

In some embodiments of this invention, the inventive nutritional compositions additionally comprise beta-hydroxy-beta-methylbutyrate (HMB), and preferably calcium HMB, which means that the nutritional compositions are either formulated with the addition of calcium HMB, most typically as a monohydrate, or are otherwise prepared so as to contain HMB in the finished composition. Any source of HMB is suitable for use herein provided that the finished product contains HMB, although such a source is preferably calcium HMB and is most typically added as such to the nutritional compositions during formulation.

Although calcium HMB monohydrate is the generally preferred source of HMB for use in the nutritional compositions disclosed herein, other suitable sources may include HMB as the free acid, a salt, an anhydrous salt, an ester, a lactone, or other product forms that otherwise provide a bioavailable form of HMB from the nutritional compositions. Non-limiting examples of suitable salts of HMB for use herein include HMB salts, hydrated or anhydrous, of sodium, potassium, magnesium, chromium, calcium, or other non-toxic salt form. Calcium HMB monohydrate is preferred and is commercially available from Technical Sourcing International (TSI) of Salt Lake City, Utah.

The concentration of HMB in the nutritional compositions may range up to 10%, including from about 0.01% to about 10%, including from about 0.01% to about 8%, and also including from about 0.08% to about 5.0%, including from about 0.08% to about 3%, including from about 0.1% to about 2.5%, by weight of the nutritional composition. In some specific embodiments, the nutritional compositions include about 0.38% or about 0.71%, by weight HMB.

The nutritional compositions of the present disclosure desirably include sufficient HMB to provide an individual with from about 0.1 grams to about 10 grams, including from about 0.5 grams to about 10 grams, including from about 1 gram to about 8 grams, including from about 2 grams to about 7 grams, and also including from about 3 grams to about 6 grams, per day of HMB. In one specific embodiment, the daily intake of HMB by the individual is about 3 grams. The total daily HMB may be contained in one, two, three, or more servings of the nutritional composition.

Further non-limiting examples of optional ingredients include preservatives, antioxidants, emulsifying agents, buffers, pharmaceutical actives, additional nutrients as described herein, colorants, flavors, thickeners (e.g., induced viscosity fibers), additional stabilizers, cereal beta-glucans (barley beta-glucan), probiotics (e.g., Lactobacillus rhamnosus HN001 (DR20)), prebiotics (fructooligosaccharides, galactooligosaccharides, inulin, oligofructose), Salacia extract, and so forth.

The inventive nutritional compositions may further comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The inventive nutritional compositions may further comprise minerals, non-limiting examples of which include phosphorus, magnesium, calcium, iron, zinc, manganese, copper, sodium, potassium, molybdenum, chromium, selenium, chloride, and combinations thereof.

The inventive nutritional compositions may also include one or more flavoring or masking agents. Suitable flavoring or masking agents include natural and artificial sweeteners, sodium sources such as sodium chloride, and hydrocolloids, and combinations thereof. Nutritional compositions which are made with vanilla, chocolate or strawberry flavoring agents are especially preferred.

The inventive nutritional compositions may also include fish oil masking agents to mask “fishy” type flavors/aroma notes that commonly occur with the presence of fish/marine oil. For example, in some embodiments, the inventive nutritional compositions may include the lipid-amylose complex described above. Specifically, the combination of monoglycerides and low DE glucose polymers, such as DE-1 maltodextrin, form a lipid-amylose complex that can bind to oxidation products such as the fatty acid chain of aldehydes or ketones formed during oxidation of marine oils.

### Methods of Manufacture

The inventive nutritional compositions may be manufactured by any known or otherwise suitable method. Inventive nutritional compositions in liquid form may be suitably sterilized either by aseptic sterilization or by retort sterilization.

In those embodiments of the invention in which the inventive nutritional compositions are in the form of a nutrition shake, they may be prepared by any of the well known methods of formulating such compositions by way of retort, aseptic packaging, or hot fill processing methods.

For example, in one suitable manufacturing process for formulating a nutrition shake, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing the oil (e.g., canola oil, corn oil) and then adding an emulsifier (e.g., lecithin), fat soluble vitamins, and a portion of the total protein (e.g., intact pea protein concentrate, milk protein concentrate) with continued heat and agitation. The CHO-MIN slurry is formed by adding with heated agitation to water: minerals (e.g., potassium citrate, dipotassium phosphate, sodium citrate), trace and ultra trace minerals (TM/UTM premix), thickening or suspending agent. The resulting CHO-MIN slurry is held for 10 minutes with continued heat and agitation before adding additional minerals (e.g., potassium chloride, magnesium carbonate, potassium iodide), and/or carbohydrates (e.g., HMOs, fructooligosaccharide, sucrose, corn syrup). The PIW slurry is then formed by mixing with heat and agitation the remaining protein, if any.

The resulting slurries are then blended together with heated agitation and the pH adjusted to 6.6-7.0, after which the composition is subjected to high-temperature short-time (HTST) processing during which the composition is heat treated, emulsified and homogenized, and then allowed to cool. Water soluble vitamins and ascorbic acid are added, the pH is adjusted to the desired range if necessary, flavors are added, and water is added to achieve the desired total solid level. The composition is then aseptically packaged to form an aseptically packaged nutritional emulsion. This emulsion can then be further diluted, heat-treated, and packaged to form a ready-to-feed or concentrated liquid.

First Aspect—Nutritional Compositions with Potato and Rice Proteins

In a first aspect of this invention, nutritional compositions of any type are made with a significant amount of potato and rice proteins. In accordance with this aspect of the invention, it has been found that the total amount of vegetable protein that a nutritional composition intended for oral consumption can include without adversely affecting its nutritional value, flavor and other desirable hedonic properties can be increased to levels of 40 wt. % or more, based on total protein, by using the combination of potato and rice proteins. That is to say, it has been found that the undesirable flavor off-notes that typically derive from different types of vegetable based proteins when used to replace a substantial portion of the milk proteins in a commercially viable nutritional composition intended for oral consumption can be largely eliminated, or at least reduced significantly, if a substantial portion of the vegetable protein used for this replacement is based on the combination of potato protein and rice proteins. Preferably, both intact rice protein and hydrolyzed rice protein are used.

As indicated above, vegetable proteins generally exhibit various undesirable flavor off-notes. This is illustrated in the following Table 5, which shows the common sensory flavor off-notes that certain common vegetable proteins exhibit:

TABLE 5
Common Sensory Off-Notes for Vegetable Proteins

| | | Potato | | |
|---|---|---|---|---|
| | | 206P/Pro | | |
| Pea | Soy | Go Clear | Hydrolyzed Rice | Intact Rice |
| green pea 1½ | Bitter 1 | Tannin 1 | Cardboard/brown | Soy |
| Bitter 1½ | Beany 1 | Potato/ | paper 1 Starchy/ | cardboard |
| Green tea 1½ | | methionine | rice water 1½ | 1½ |
| | | 1 | Bitter 1 | Bitter ½ |

Because of these off-notes, experience has shown that when the amount of vegetable protein in commercially viable nutritional compositions intended for oral consumption begins exceeding roughly 30 wt. %, based on total protein, undesirable flavor notes begin to appear.

In accordance with a first aspect of this invention, it has been found that the amount of vegetable protein that can be included in nutritional compositions intended for oral consumption can be increased to 40 to 65 wt. % or more, based on total protein, without introducing undesirable flavor notes if about 40% or more of the vegetable protein used for this purpose is composed of two or more of potato protein, intact rice protein and hydrolyzed rice protein.

In preferred embodiments, about 45% or more, or even about 50% or more of the vegetable protein is composed of the combination of potato and rice proteins, more preferably the combination of potato protein, intact rice protein and hydrolyzed rice protein. Also, in those compositions containing both potato and rice proteins, the weight ratio of rice protein to potato protein desirably ranges from about 5:1 to 1:1, more desirably about 3/1 to 1.5/1, 2.5/1 to 1.75/1 or even about 2/1. In this context, it will be understood that “rice proteins” refers to any type of rice protein whether derived from white rice or brown rice and whether hydrolyzed or intact.

These compositions typically will also contain significant amounts of soy protein. So, compositions of this type may contain >30 wt. % soy protein, >0-20 wt. % rice protein and >0-10 wt. % potato protein, based on total vegetable protein, with the ratio of rice protein plus potato protein, on the one hand, to soy protein, on the other hand, typically being about 3:1-1:3, 2:1-1:2, 1.5:1-1:1.5 and even about 1:1.

In this first aspect of the invention, the protein component of the inventive nutritional compositions comprises about 35 to 60 wt. % milk protein, based on total protein. The remaining protein in these compositions is vegetable protein, at least 40% of which is composed of a mixture of at least two of potato protein, intact rice protein and hydrolyzed rice protein. Preferably, at least 40 wt % of the vegetable protein comprises potato protein and one or both of intact rice protein and hydrolyzed rice protein. More preferably, all three of potato protein, intact rice protein and hydrolyzed rice protein are present. In especially interesting embodiments, at least 50 wt % of the vegetable protein comprises potato protein and at least one of (and preferably both of) intact rice protein and hydrolyzed rice protein.

The remaining vegetable protein in the nutritional compositions of this aspect of the invention, i.e., the portion of vegetable protein not comprising potato, intact rice and hydrolyzed rice proteins, can be composed of any vegetable protein useful for making nutritional compositions. Specific examples include proteins derived from wheat, corn, hemp, and the other proteins mentioned above. Most commonly, however, the remaining vegetable protein in these compositions will be composed predominantly of soy protein. That is to say, at least about 50 wt % of this remainder will be composed of soy protein. Pea protein may also be included in this remainder, although compositions which contain little (i.e., 5% or less) or essentially no pea protein are also contemplated.

Compositions in which the combined amounts of potato protein, intact rice protein and hydrolyzed rice protein in the nutritional composition represent about 10 to 50 wt. %, and especially 20 to 45 wt. %, of the total protein in the composition are more interesting. Similarly, compositions in which at least 10 wt. % of the vegetable protein comprises potato protein, and further in which at least 20 wt. % of the vegetable protein comprises intact rice protein, hydrolyzed rice protein or a mixture thereof are also more interesting. In this the same way, compositions in which at least 15 wt. % of the vegetable protein comprises potato protein, and further wherein at least 30 wt. % of the vegetable protein comprises intact rice protein, hydrolyzed rice protein or a mixture thereof are even more interesting.

Other compositions of special interest are those in which at least 10 wt. % of the vegetable protein comprises potato protein, at least 10 wt. % of the vegetable protein comprises intact rice protein, and at least 10 wt. % of the vegetable protein comprises hydrolyzed rice protein. Similarly, compositions in which at least 15 wt. % of the vegetable protein comprises potato protein, at least 15 wt. % of the vegetable protein comprises intact rice protein, and at least 20 wt. % of the vegetable protein comprises hydrolyzed rice protein are also of special interest

Particular compositions of interest are those in which the protein component of the nutritional composition comprises (a) about 35 to 60 wt. % milk protein, (b) about 5 to 30 wt. % potato protein, (c) about 5 to 30 wt. % of at least one of intact rice protein and hydrolyzed rice protein, and (d) a balance composed primarily of soy protein. Especially interesting compositions of this type are those in which the protein component comprises (a) about 35 to 60 wt. % milk protein, (b) about 5 to 25 wt. % potato protein, (c) about 5 to 20 wt. % intact rice protein, (d) about 5 to 30 wt. % of hydrolyzed rice protein, and (e) a balance composed primarily of soy protein.

Any commercially available potato protein can be used for making the nutritional compositions of this first aspect of the invention. Similarly, any commercially available intact rice protein can be used for making the nutritional compositions of this first aspect of the invention, both those derived from white rice proteins as well as those derived from brown rice proteins. In the same way, any commercially available hydrolyzed rice protein can be used for making the nutritional compositions of this first aspect of the invention, both those derived from white rice as well as those derived from brown rice, provided that it exhibits a degree of hydrolysis (DH) of about 5 to 25%. Preferably, the degree of hydrolysis of these hydrolyzed proteins is about 5 to 15%.

Although any type of milk protein can be used to make the nutritional compositions of this first aspect of the invention, it is desirable that the primary source of milk proteins in the nutritional compositions of this first aspect is desirably a milk protein concentrate (MPC), i.e., a product which has an average protein content of about 70 to 90 wt. % and which has a natural whey protein/casein ratio between about 10:90 and 30:70. Normally, these products are available in the form of a powder prepared by ultrafiltration Preferred milk protein concentrates have an average protein content of about 75 to 85 wt. %, and a natural whey protein/casein ratio between about 10:90 and 20:80. MPC is a preferred source of milk protein because it is relatively inexpensive, readily available, has a preferred flavor profile, and exhibits a beneficial effect on product stability. In addition, it already exhibits a natural distribution of whey protein and casein, e.g., about 20/80 on a weight basis.

Other sources of milk proteins can also be used in the nutritional compositions of this aspect of the invention as well. If so, the total amount of these other milk protein sources is desirably ≦20 wt. %, more preferably ≦10 wt. %, or even ≦5 wt. %, of the total amount of MPC in the composition. In some embodiments, no additional source of milk protein is used. In any event, regardless of the type and amount of additional milk protein sources used, if any, it is desirable that the ratio of whey protein to casein in the nutrition compositions of this first aspect also does not exceed 0.375:1.

As indicated above, typically about one half (e.g., about 45 to 55 wt. %) of the total amount of vegetable proteins in the nutritional compositions of this first aspect of the invention will be composed of at least one of potato protein, intact rice protein and hydrolyzed rice protein. In some embodiments of this first aspect of the invention, however, these nutritional compositions will contain the combination of at least two (and, in some instances all three) of potato, intact rice and hydrolyzed rice proteins. Indeed, it is contemplated that, in some embodiments, the combination of potato and one or both of intact rice protein and hydrolyzed rice protein can represent as much as 60 wt. %, 70 wt. %, 80 wt. %, or even 90 wt. % of total vegetable protein in these compositions.

So, in particular examples of the nutritional compositions of this first aspect of the invention, the protein component of the nutritional composition can comprise (a) about 35 to 60 wt. % milk protein, (b) about 30 to 50 wt. % soy protein, (c) about 2 to 10 wt. % potato protein, and (d) about 4 to 20 wt. % of one or both of intact rice protein and hydrolyzed rice protein.

In other particular examples of the nutritional compositions of this first aspect of the invention, the protein component of the nutritional composition can comprise (a) about 35 to 60 wt. % milk protein, (b) about 30 to 50 wt. % soy protein, (c) about 2 to 10 wt. % potato protein, and (d) about 2 to 10 wt. % intact rice protein, and (e) about 2 to 10 wt. % hydrolyzed rice protein.

In still other particular examples, the protein component of these nutritional composition can comprise (a) about 35 to 60 wt. % milk protein, (b) about 5 to 40 wt. % potato protein, (c) about 5 to 40 wt. % intact rice protein, and (d) about 5 to 40 wt. % of hydrolyzed rice protein.

In yet other particular examples, the protein component of these nutritional composition can comprise (a) about 35 to 60 wt. % milk protein, (b) about 15 to 20 wt. % potato protein, (c) about 15 to 20 wt. % intact rice protein, and (d) about 15 to 20 wt. % of hydrolyzed rice protein.

When formulated into nutrition shakes, the nutritional compositions of this first aspect of the invention desirably exhibit a viscosity of <80 cps at 20° C., more commonly <50 cps, <40 cps, or even <30 cps, at 20° C., a graininess factor of <2, preferably <1.5, or even ≦1, and overall liking score of >5, at a confidence level of at least 95%.

In this regard, viscosity is a well known property of liquid nutritional compositions that can be easily determined using a Brookfield viscometer, No. 1 Spindle. The inventive nutrition shakes of this first aspect of the invention are desirably formulated to have essentially the same viscosities as the commercial shakes being modified by the technology of this invention. A few of these commercial nutrition shakes have viscosities as high as 80 cps at 20° C. Most, however, have viscosities of <50 cps, at 20° C. Accordingly, the inventive shakes are normally formulated in such a way that they exhibit viscosities of <80 cps at 20° C., more commonly <50 cps, <40 cps, or even <30 cps, at 20° C.

When proteins from different sources are included in the same nutritional composition, they tend to agglomerate over time. When a nutrition shake is used, this agglomeration manifests itself as small, distinct grains or particles which deposit on the side of a glass or container from which the nutrition shake is poured. To measure the degree or extent to which this phenomenon occurs, an analytical test has been developed in which a solid 1/16 inch diameter wire is formed into a loop measuring 1 inch in diameter. The loop is then dipped into the sample to be tested to form a flat film of product across the loop. The loop is then held up to a light source and visually rated for amount of protein particles present in the film, using a rating scale of 1 (best) to 6 (worst). In accordance with this invention, the nutrition shakes of this first aspect of this invention are formulated in such a way that they exhibit a graininess factor when measured by this analytical test of <2. Preferably, the inventive nutrition shakes exhibit a graininess factor of <1.5, or even ≦1.

Hedonic testing is a well known method of evaluating nutritional compositions for overall desirability. In a typical hedonic test, a group of subjects is asked to independently evaluate different samples for aroma, color, flavor, sweetness, thickness, mouthfeel, aftertaste, and overall liking Each subject is then asked to rate each of these properties on the following 9 point Hedonic scale: 1=Dislike Extremely; 5=Neither Like or Dislike; 6=Like Slightly; 7=Like Slight to Moderately; 8=Like Moderately; 9=Like Extremely. The mean score for each property is then determined, which can provide an accurate assessment of the particular property being assessed. Depending on the number subjects used in the test, the property being assessed although subjective in nature can be objectively determined with a reasonable level of confidence. For example, in a hedonic evaluation carried out with a group of 100 subjects, the subjective properties mentioned above can be determined with a 95% confidence level.

In accordance with this invention, it is believed that the nutrition shakes of this first aspect of the invention will exhibit an overall liking score of >5, at a confidence level of at least 95%. In the context of this invention, this suggests that these nutrition shakes should be regarded by the vast majority of the consuming public as exhibiting a neutral overall desirability. Preferably, these nutrition shakes will be formulated to exhibit an overall liking score of >6, at a confidence level of at least 95%. In the context of this invention, this means that these nutrition shakes should be regarded by the vast majority of the consuming public as being more desirable than not.

To illustrate the first aspect of this invention more thoroughly, three different liquid nutritional compositions were prepared using the protein packages of this aspect of the invention. The content of each of these protein packages, based on total protein, is set forth in the following Table 6:

TABLE 6
Protein Content of Protein Packages, based on Total Protein

| | Ex 1 | | Ex 2 | | Ex 3 | | Ex 3 | |
|---|---|---|---|---|---|---|---|---|
| | % total | % veg | % total | % veg | % total | % veg | % total | % veg |
| Protein | protein | protein | protein | protein | protein | protein | protein | protein |
| milk | 40 | — | 50 | — | 50 | — | 50 | — |
| soy | 25 | 41.7 | 20 | 40 | 20 | 40 | 40 | 80 |
| intact white | 10 | 16.7 | — | — | 10 | 20 | 10 | 20 |
| rice | | | | | | | | |
| hydrolyzed | 15 | 25 | 10 | 20 | 10 | 20 | — | — |
| rice | | | | | | | | |
| potato | 10 | 16.7 | 20 | 40 | 10 | 20 | — | — |

The amino acid profile of each of these protein packages is set forth in the following Table 7. In addition, the minimum amounts of indispensible amino acids that should be present in foods intended for consumption by normal healthy adults as established by the Food and Agriculture Organization of the United Nations (“FAO”) for calendar year 2007 are set forth in this table, as are the minimum amounts of these proteins established by the Food and Nutrition Board of the Institute of Medicine (“FNB”) for calendar year 2005, for the purposes of comparison.

TABLE 7
Amino Acid Profile of Exemplary Protein Packages

| Amino Acid | FNB | FAO | milk | Ex 1 | Ex 2 | Ex 3 | Ex 4 |
|---|---|---|---|---|---|---|---|
| Isoleucine\hat{ }* | 30 | 30 | 58 | 51 | 54 | 53 | 53 |
| Leucine\hat{ }* | 59 | 59 | 95 | 89 | 92 | 91 | 89 |
| Lysine* | 45 | 45 | 76 | 61 | 69 | 64 | 66 |
| Methionine*⁺ | — | — | 25 | 22 | 20 | 22 | 21 |
| Methionine*⁺ + | 22 | 22 | 33 | 36 | 34 | 36 | 32 |
| Cystine⁺ | | | | | | | |
| Phenylalanine*′ | — | — | 47 | 52 | 53 | 51 | 50 |
| Phenylalanine*′ + | 38 | 38 | 95 | 100 | 101 | 99 | 94 |
| Tyrosine′ | | | | | | | |
| Tryptophan*′ | 6.0 | 6.0 | 13 | 12 | 11 | 12 | 13 |
| Threonine* | 23 | 23 | 46 | 40 | 42 | 42 | 42 |
| Valine\hat{ }* | 39 | 39 | 62 | 61 | 64 | 61 | 57 |
| Histidine*′ | 15 | 15 | 26 | 25 | 24 | 25 | 26 |
| Branched chain | — | — | 215 | 201 | 210 | 204 | 199 |
| amino acids | | | | | | | |
| Arginine | | | 34 | 57 | 50 | 53 | 56 |
| Glutamic acid | | | 198 | 179 | 171 | 181 | 194 |

\hat{ }Branched chain amino acid
*Essential amino acid
⁺Sulfur amino acids
′Aromatic amino acids

As can be seen from Table 7, the protein packages of this aspect of this invention meet all of the requirements of both the FAO and the FNB in connection with the minimum amounts of indispensible amino acids. This is particularly advantageous, because (other than soy protein) the other vegetable proteins commonly used for replacing milk and other animal proteins in nutritional compositions are deficient in one or more of these amino acids. For example, rice proteins are deficient in lysine, while pea proteins are deficient in methionine plus cystine. Accordingly, by suitable selection of the combination of rice and potato proteins in accordance with this aspect of the invention, it is possible not only to increase the relative amount of vegetable protein in such compositions without adversely affecting taste and other hedonic properties but also to do so in a manner which achieves the necessary nutritional value in terms of amino acid content.

To further illustrate the first aspect of this invention, the above protein packages were used to formulate three specific test liquid nutritional compositions. These test liquid nutritional compositions, which are patterned after commercially available nutrition shakes, were formulated to contain about 30 wt % total protein. The composition of each of these test liquid nutritional compositions is set forth in the following Table 8:

TABLE 8
Nutritional Shake with Vegetable proteins (30% protein system)

| Ingredient | Ex 1 | Ex 2 | E 3 | Ex 4 |
|---|---|---|---|---|
| Water | Q.S. | Q.S. | Q.S. | Q.S. |
| Sucrose | 88.1 | 88.4 | 88.1 | 88.6 |
| Maltrin M100 | 69.9 | 70.1 | 69.9 | 70.3 |
| Milk Protein Concentrate | 16.7 | 20.9 | 20.9 | 20.9 |
| Soy Oil | 12.9 | 13.1 | 13.0 | 13.2 |
| Soy Protein Isolate | 10.1 | 8.10 | 8.10 | 20.2 |
| Axiom SG-BN | 7.09 | 4.73 | 4.73 | — |
| (hydrolyzed rice protein) | | | | |
| Canola Oil | 5.19 | 5.28 | 5.24 | 5.29 |
| Shanghai Freemen 90+ | 4.65 | — | 4.65 | — |
| (Rice Protein) | | | | |
| Corn Oil | 3.97 | 4.04 | 4.01 | 4.05 |
| Solanic ProGo Clear - | 3.86 | 7.73 | 3.86 | — |
| Potato protein | | | | |
| Magnesium Phosphate | 2.74 | 2.72 | 2.72 | 2.70 |
| Avicel CL611 | 2.40 | 2.40 | 2.40 | 2.40 |
| Givaudan N&A Vanilla | 2.00 | 2.00 | 2.00 | 2.00 |
| Calcium Carbonate | 1.49 | 1.38 | 1.38 | 1.37 |
| Micronized Tricalcium | 1.43 | 1.33 | 1.33 | 1.31 |
| Phosphate | | | | |
| Potassium Citrate | 1.23 | 1.39 | 1.26 | 1.47 |
| Sodium Citrate | 1.02 | 1.31 | 1.22 | 0.857 |
| Potassium Chloride | 0.940 | 0.866 | 0.941 | 1.01 |
| Sodium Chloride | 0.668 | 0.615 | 0.668 | 0.714 |
| Choline Chloride | 0.480 | 0.480 | 0.480 | 0.480 |
| Ascorbic Acid | 0.469 | 0.469 | 0.469 | 0.469 |
| Potassium Citrate | 0.385 | 0.308 | 0.327 | — |
| UTM/TM Premix | 0.364 | 0.364 | 0.364 | 0.364 |
| 45% Potassium | 0.323 | 0.323 | 0.323 | 0.323 |
| Hydroxide | | | | |
| Soy Lecithin | 0.283 | 0.288 | 0.286 | 0.288 |
| Myverol 18-06 (Distilled | 0.283 | 0.288 | 0.286 | 0.288 |
| Monoglyceride) | | | | |
| Viscarin SA-359 | 0.160 | 0.160 | 0.160 | 0.160 |
| Seakem Carrageenan | 0.0800 | 0.0800 | 0.0800 | 0.0800 |
| WSV Premix | 0.0690 | 0.0690 | 0.0690 | 0.0690 |
| Vitamin DEK Premix | 0.0653 | 0.0653 | 0.0653 | 0.0653 |
| Vitamin A Palmitate | 0.00790 | 0.00790 | 0.00790 | 0.00790 |
| Potassium Iodide | 0.000207 | 0.000207 | 0.000207 | 0.000207 |

Second Aspect—Nutritional Compositions with Low Phytic Acid Legume Proteins

In a second aspect of this invention, nutritional compositions of any type for oral consumption by humans are made with a protein package composed entirely of vegetable protein, at least 50 wt. % of this protein package based on total protein being composed of legume protein having a low phytic acid content.

In addition to poor taste, many vegetable proteins suffer from additional drawbacks which make it difficult or impossible, as a practical matter, to formulate nutritional compositions containing only vegetable proteins. Thus, many vegetable proteins are deficient in one or more indispensable amino acids. For example, proteins derived from corn, wheat and rice are deficient in lysine. Accordingly, nutritional compositions made with these vegetable proteins are normally supplemented with dairy proteins or specific amino acids such as lysine, methionine, etc. to supply these missing indispensable amino acids.

Other vegetable proteins contain undesirable ingredients, and hence the concentrations of these vegetable proteins in any particular nutritional composition should be limited. For example, the legume proteins commonly used in nutritional compositions including soy protein, pea protein and lentil protein normally contain approximately 2-3 wt. % phytic acid. See, for example, Wang et al., Food Chem., 95 (2006) 493-502 and Blatny et al., J. Agric. Food Chem., 43 (1995) 129-133. Phytic acid and its salts (phytates) are regarded as “antinutrients,” not only because they are indigestible by humans and other animals but also because they act as chelates especially for iron and zinc, thereby rendering these valuable minerals unavailable for digestion as well. Accordingly, care must be taken in formulating particular nutritional compositions to avoid including too much of these vegetable proteins to prevent the concentration of phytic acid in the compositions from becoming too high. Again, this is normally done by supplementing nutritional compositions made with these vegetable proteins with a significant amount of dairy protein. Alternatively, if nutritional compositions with 100% vegetable proteins are required, additional amounts of these chelated minerals need to be added.

In accordance with this second aspect of this invention, it has been found that these problems can be avoided in nutritional compositions containing 100% vegetable proteins, provided that at least half of these vegetable proteins are legume proteins exhibiting a reduced phytic acid content. In particular, it has been found that nutritional composition in which the protein component is compliant with current (i.e., 2013) FAO protein quality requirements for adults and whose concentration of phytic acid and associated salts (i.e., phytates) is no more than 1 gram per 100 grams of protein (i.e., ≦1 g/100 g protein) can be produced from 100% vegetable proteins, provided that at least half of these vegetable proteins are composed of soy, pea or lentil proteins, or mixtures of these proteins, containing a reduced phytic acid concentration.

In this regard, in the context of this document, unless expressly indicated otherwise or clear from context, reference to phytic acid will also be understood to include reference to both phytic acid and its corresponding salts. So, for example, “phytic acid concentration” will be understood to mean the combined concentrations of both phytic acid and its corresponding salts. And for this purpose, the “corresponding salts” of phytic acid will be understood to mean the salts phytic acid inherently forms when combined with the other ingredients of a nutritional composition in which the phytic acid is contained.

Also, in the context of this document, a “reduced phytic acid concentration” will be understood to mean ≦1.5 g phytic acid per 100 g protein in the case of lentil protein, ≦0.7 g phytic acid per 100 g protein in the case of pea protein and ≦0.7 g phytic acid per 100 g protein in the case of soy protein, with “phytic acid” including phytates in keeping with the above convention. In preferred embodiments of this second aspect of the invention, the lentil, pea and soy proteins used to make the nutritional compositions have the following phytic acid concentrations: <1.3 g phytic acid per 100 g protein in the case of lentil protein, <0.5 g phytic acid per 100 g protein in the case of pea protein and <0.5 g phytic acid per 100 g protein in the case of soy protein.

As well understood in the nutrition arts, the Food and Agriculture Organization of the United Nations, which is commonly referred to as the “FAO,” has established certain requirements for the quality of the proteins in foods intended for adult consumption. In particular, the FAO has established standards for the minimum amounts of indispensible amino acids that should be present in foods intended for consumption by normal healthy adults.

In this regard, the concentrations of indispensible amino acids in the proteins derived from lentils, peas and soybeans is given in the following Table 5:

TABLE 5
Concentrations as mg per g of Protein

| Indispensable | Lentil | | |
|---|---|---|---|
| amino acid | protein^{a} | Pea protein^{b} | Soy protein^{c} |
| His | 28 | 24 | 26 |
| Ile | 46 | 41 | 49 |
| Leu | 72 | 72 | 82 |
| Lys | 68 | 72 | 63 |
| Met + Cys | 29 | 25 | 26 |
| Phe + Tyr | 78 | 75 | 90 |
| Thr | 36 | 36 | 38 |
| Trp | 7 | 11 | 12 |
| Val | 50 | 47 | 51 |

^{a}Wang N and Daun JK, Food Chem, 95 (2006) 493-502
^{b}USDA Nutrient Database, entry 16085
^{c}USDA Nutrient Database, entry 16175

However, as well appreciated in the nutrition arts, not all of the amino acids contained in particular proteins are normally digested by a human or other animal. That is to say, for each particular amino acid derived from each particular protein, less than 100% of that amino acid is taken up by the digestive tract. Rather, some percentage of each protein, for example 80-95% or more depending on the particular amino acid as well as the particular protein, is taken up. For example, only about 96% of the lysine in lentil protein is normally taken up by the digestive tract of most mammals. This percentage, which is known as the “ileal digestibility factor” is different for each amino acid derived from each protein. Accordingly, to determine the amount of indispensible amino acids that are available for digestion from particular proteins (which is referred to as the “digestible indispensible amino acid concentration” or the “DIAA concentration”) the gross amount of that amino acid in each protein must be multiplied by the appropriate ileal digestibility factor.

To this end, the concentrations of digestible indispensible amino acids in lentil, pea and soy proteins are set forth in the following Table 6, along with the current (2013) FAO protein quality requirements for normal healthy adults:

TABLE 6
Digestible Indispensable Amino Acid Concentrations, mg/g Protein

| | FAO | | | |
|---|---|---|---|---|
| Indispensable | minimum, | | | |
| amino acid | adult^{a} | Lentil protein^{b} | Pea protein^{b} | Soy protein^{c} |
| His | 16 | 26 | 22 | 24 |
| Ile | 30 | 43 | 38 | 46 |
| Leu | 61 | 67 | 67 | 77 |
| Lys | 48 | 65 | 68 | 60 |
| Met + Cys | 23 | 27 | 23 | 25 |
| Phe + Tyr | 41 | 76 | 73 | 87 |
| Thr | 25 | 32 | 32 | 33 |
| Trp | 6.6 | 6.6 | 10 | 12 |
| Val | 40 | 46 | 43 | 47 |

^{a}FAO Food and Nutrition Paper 92, 2013, Table 5, page 29
^{b}digestibility values from Gaudichon et al., Gastroenterol, 123 (2002) 50-59

As can be seen from Table 6, lentil, pea and soy proteins already meet the current (2013) FAO protein quality requirements for normal healthy adults. Unfortunately, conventional sources of these proteins typically contain 2-3 g phytic acid per 100 grams of protein, which is undesirable from a total nutritional value standpoint, because of its antinutrient activity as mentioned above. Although the phytic acid concentration in “non-legume” vegetable proteins may be lower such as in those derived from corn, wheat and rice, for example, such non-legume vegetable proteins are deficient one or more indispensible amino acids.

As a result, a dilemma is faced when formulating nutritional compositions containing conventional vegetable proteins only, this dilemma being that (1) if substantial amounts of non-legume proteins are used, the composition will be deficient in one or more indispensible amino acids, thereby requiring that these missing amino acids be separately added, or (2) if enough legume-derived vegetable proteins are used to supply the necessary concentrations of indispensible amino acids, the composition will include an undesirably high amount of phytic acid, thereby requiring that the valuable mineral nutrients that are taken up and rendered indigestible by the phytic acid be separately added.

In accordance with the second aspect of this invention, this dilemma is avoided by formulating the nutritional composition from certain legume-derived proteins which have a reduced phytic acid content.

Legume proteins which exhibit a reduced concentration of phytic acid have been recently developed and are described in a number of different publications. For example, according to Thavarajah P, et al., J Agric Food Chem, 57 (2009) 9044-9049, lentil protein containing about 1.3 grams phytic acid per 100 grams protein can be recovered from specially grown crops which express low phytate. Similarly, according to Fredrikson M, et al., J Agric Food Chem, 49 (2001)1208-1212, pea protein containing <0.5 gram phytic acid per 100 grams protein can be recovered from conventional pea protein which has been processed with a suitable phytase. In addition, according to Raboy V, J Nutr, 132 (2002) 503S-505S, soy protein containing <0.5 gram phytic acid per 100 grams protein can be recovered from specially grown crops which express low phytate. In accordance with this aspect of the invention, a sufficient amount of one or more “reduced phytic acid” legume proteins such as described in these publications is used optionally together with other non-legume derived proteins to provide nutritional compositions which (1) are made with 100% vegetable protein, (2) meet the current (2013) FAO protein quality requirements for normal healthy adults, and (3) contain no more than 1 gram phytic acid (including phytates) per 100 grams of protein (i.e., ≦1 g phytic acid/100 g protein).

Normally, the amount of reduced phytic acid legume proteins in these compositions will be at least 50 wt. % of total protein. In other embodiments, however, the amount reduced phytic acid legume proteins in these compositions will be at least 60 wt. %, at least 70 wt. %, at least 80 wt. %, or even at least 90 wt. %, of total protein. Nutritional compositions in which 100% of the protein component is composed of one or more reduced phytic acid legume proteins are also contemplated.

Specific examples of the protein component in such compositions is set forth in the following Table 7:

TABLE 7
Examples of Protein Systems in a Low Phytate
Vegetable Protein Composition

Example

| | A | B | C | D |
|---|---|---|---|---|
| Total protein, | 36 | 36 | 36 | 52 |
| g/kg | | | | |
| Lentil protein, | 20% | 40% | 0% | 20% |
| % of total | | | | |
| Pea protein, % | 10% | 0% | 15% | 10% |
| of total | | | | |
| Soy protein, % | 70% | 60% | 85% | 70% |
| of total | | | | |
| Phytic acid, g | 0.7 | 0.8 | 0.5 | 0.7 |
| per 100 g of | | | | |
| total protein | | | | |

Although only a few embodiments have been described above, it should be appreciated that many modifications can be made without departing from the spirit and scope of the invention. All such modifications are intended to be included within the scope of this invention, which is to limited only by the following claims.

1. A nutritional composition comprising a carbohydrate component in an amount of from 5% to 65% by weight, a fat component in an amount of from 1% to 20% by weight, and a protein component in an amount of from 1% to 20% by weight, these percents being based on the weight of the nutritional composition as a whole, wherein the protein component comprises either
(a i) 35 to 60 wt. % milk protein, and
(a ii) 40 to 65 wt. % vegetable protein, comprising at least two of soy protein, hydrolyzed soy protein, potato protein, intact rice protein and hydrolyzed rice protein having a degree of hydrolysis (DH) of 5% to 25%, or
(b i) 100% vegetable protein, wherein at least half of the vegetable protein is composed of one or more legume proteins exhibiting a reduced phytic acid concentration, and further wherein the protein component meets the current (2013) FAO protein quality requirements for normal health adults.

2. The nutritional composition of claim 1, wherein the nutritional composition has a protein component comprising
(a i) 35 to 60 wt. % milk protein, and
(a ii) 40 to 65 wt. % vegetable protein, comprising at least two of soy protein, hydrolyzed soy protein, potato protein, intact rice protein and hydrolyzed rice protein having a degree of hydrolysis (DH) of 5% to 25%.

3. The nutritional composition of claim 2, wherein at least a quarter of the vegetable protein comprises at least one of potato protein, intact rice protein and hydrolyzed rice protein.

4. The nutritional composition of claim 1, wherein the vegetable protein comprises potato protein, soy protein, and at least one of intact rice protein and hydrolyzed rice protein.

5. (canceled)

6. The nutritional composition of claim 1, wherein the combined amounts of potato protein, intact rice protein and hydrolyzed rice protein in the nutritional composition represent 10 to 50 wt. % of the total protein in the composition.

7. (canceled)

8. (canceled)

9. The nutritional composition of claim 1, wherein at least 10 wt. % of the vegetable protein comprises potato protein, and further wherein at least 20 wt. % of the vegetable protein comprises intact rice protein, hydrolyzed rice protein, or a mixture thereof.

10. (canceled)

11. The nutritional composition of claim 1, wherein at least 10 wt. % of the vegetable protein comprises potato protein, at least 10 wt. % of the vegetable protein comprises intact rice protein, and at least 10 wt. % of the vegetable protein comprises hydrolyzed rice protein.

12. The nutritional composition of claim 11, wherein at least 15 wt. % of the vegetable protein comprises potato protein, at least 15 wt. % of the vegetable protein comprises intact rice protein, and at least 20 wt. % of the vegetable protein comprises hydrolyzed rice protein.

13. The nutritional composition of claim 1, wherein the protein component of the nutritional composition comprises (a) 35 to 60 wt. % milk protein, (b) 30 to 50 wt. % soy protein, (c) 2 to 10 wt. % potato protein, and (d) 4 to 20 wt. % of one or both of intact rice protein and hydrolyzed rice protein.

14. The nutritional composition of claim 13, wherein the protein component of the nutritional composition comprises comprise (a) 35 to 60 wt. % milk protein, (b) 30 to 50 wt. % soy protein, (c) 2 to 10 wt. % potato protein, (d) 2 to 10 wt. % intact rice protein, and (e) 2 to 10 wt. % hydrolyzed rice protein.

15. The nutritional composition of claim 1, wherein at least 80 wt. % of the milk protein in the inventive nutrition shake is supplied in the form of a natural milk protein concentrate (MPC) containing 70 to 90 wt. % milk proteins and having a whey protein/casein protein ratio between 10:90 and 30:70.

16. The nutritional composition of claim 1, wherein the nutritional composition is a nutrition shake.

17. The nutritional composition of claim 1, wherein the nutritional composition has a protein component comprising
(b i) 100% vegetable protein, wherein at least half of this vegetable protein is composed of one or more legume proteins exhibiting a reduced phytic acid concentration, and further wherein this protein component meets the 2013 current (2013) FAO protein quality requirements for normal health adults.

18. The nutritional composition of claim 17, wherein the one or more legume proteins exhibiting a reduced phytic acid concentration is selected from the group consisting of lentil protein, pea protein and soy protein.

19. The nutritional composition of claim 18, wherein the nutritional composition contains one or more of the following legume proteins: lentil protein containing ≦1.5 g of phytic acid per 100 g protein, pea protein containing ≦0.7 g of phytic acid per 100 g protein, and soy protein containing ≦0.7 g of phytic acid per 100 g protein.

20. The nutritional composition of claim 18, wherein the nutritional composition contains one or more of the following legume proteins: lentil protein containing <1.3 g of phytic acid per 100 g protein, pea protein containing <0.5 g of phytic acid per 100 g protein, and soy protein containing <0.5 g of phytic acid per 100 g protein.

21. The nutritional composition of claim 17, wherein at least 60 wt. % of the protein in the nutritional composition is composed of one or more legume proteins exhibiting a reduced phytic acid concentration.

22. The nutritional composition of claim 21, wherein at least 70 wt. % of the protein in the nutritional composition is composed of one or more legume proteins exhibiting a reduced phytic acid concentration.

23. The nutritional composition of claim 22, wherein at least 80 wt. % of the protein in the nutritional composition is composed of one or more legume proteins exhibiting a reduced phytic acid concentration.

24. The nutritional composition of claim 23, wherein at least 90 wt. % of the protein in the nutritional composition is composed of one or more legume proteins exhibiting a reduced phytic acid concentration.

25. (canceled)
